(19) United States
(12) Patent Application Publication
(10) Pub. No.: US 2026/0247217 A1
(43) Pub. Date: Aug. 20, 2026

(54) LOAD DISTRIBUTION DEVICE, LOAD DISTRIBUTION SYSTEM, LOAD DISTRIBUTION METHOD, AND LOAD DISTRIBUTION PROGRAM

(71) Applicant: NTT, Inc., Tokyo (JP)

(72) Inventors: Takeshi Yamada, Musashino-shi, Tokyo (JP); Kenta Shinohara, Musashino-shi, Tokyo (JP); Susumu NAKAZAWA, Musashino-shi, Tokyo (JP)

(21) Appl. No.: 18/876,793

(22) PCT Filed: Jun. 29, 2022
(86) PCT No.: PCT/JP2022/025967

§ 371 Date: Dec. 19, 2024

(51) Int. Cl. H04W 28/08; H04L 12/46; H04L 67/56

(52) U.S. Cl. CPC H04W 28/08; H04L 12/46; H04L 67/56

(57) ABSTRACT

There is provided an SMF (33) configured to: receive a PDU session establishment request including an ID of a PDU session from a UE (41), and select a UPF (21) as a load distribution destination from a plurality of UPFs (21) ; return address information of a gateway (36) that relays the PDU session to the UE (41); notify the gateway (36) of correspondence information between the ID of the PDU session and the selected UPF (21); and perform control such that a data signal which arrives at the gateway (36) from the UE (41) via the PDU session is transferred to the selected UPF 21.

### TECHNICAL FIELD

The present invention relates to a load distribution device, a load distribution system, a load distribution method, and a load distribution program.

### BACKGROUND ART

A load distribution technique is a technique of improving integral processing capability by causing a load distribution device such as a load balancer to distribute a load to any of a plurality of processing servers as load distribution destinations. The processing server processes a corresponding load and then processes another load. Therefore, in order to sequentially process many loads, the processing server generally adopts a stateless method that does not need to hold a state of a processed result after returning the processed result. Hereinafter, a stateless load distribution technique will be exemplified.

Non Patent Literature 1 describes a method for implementing load distribution in units of services or the like by a container orchestrator such as Kubernetes in a web protocol such as a hypertext transfer protocol (HTTP) or a hypertext transfer protocol secure (HTTPS).

Non Patent Literature 2 describes a mechanism for performing load distribution on an appliance machine of a load balancer manufacturer for a protocol that is relatively popular among protocols used in public communication networks such as a session initiation protocol (SIP).

### CITATION LIST

### Non Patent Literature

Non Patent Literature 1: Kubernetes, “Ingress”, [online], [retrieved on Jun. 24, 2022], Internet <URL: https://kubernetes.io/ja/docs/concepts/services-networking/ingress/>, published on Oct. 8, 2021.

Non Patent Literature 2: radware, “Alteon virtual load balancer & appliance”, [online], [retrieved on Jun. 24, 2022], Internet <URL: https://jp.radware.com/products/alteon-va/>

### SUMMARY OF INVENTION

### Technical Problem

A 5th generation core network (5GC) has been proposed as a network system corresponding to a 5th generation (5G) communication standard of wireless communication such as a mobile phone. It is considered to construct a processing server as a load distribution destination in 5GC as a container-type application called a user plane function (UPF). At this time, it is required to satisfy the following requirements.

(Requirement 1) For security measures of 5GC, it is necessary to hide a configuration of the UPF from a viewpoint of hiding a configuration of an internal network.

(Requirement 2) In 5G, a C-plane (control signal) and a U-plane (user data) are separated. Therefore, in call control processing of a protocol data unit (PDU) session which is a communication connection in 5G, load distribution in which a stateful C-plane and a U-plane cooperate with each other is required.

Hereinafter, (Requirement 1) will be described with reference to FIG. 13 and FIG. 14.

FIG. 13 is a configuration diagram illustrating an example of a 5GC system.

The 5GC system has a configuration in which a data network (DN) 11, user plane functions (UPFs) 21 to 23, a next generation nodeB (gNB) 31, an access and mobility management function (AMF) 32, a session management function (SMF) 33, and user equipment (UE) 41 corresponding to network functions (NF) are connected via a network.

The DN 11 is various networks other than 5G, and is, for example, the Internet or a system equivalent to a telephone exchanger such as IP multimedia subsystems (IMS).

The UPFs 21 to 23 are user plane functions of transferring data (U-plane) transferred from a user, and operate as a processing server of a load distribution destination.

The AMF 32 is an access and movement management function, and manages terminal location information and authentication information.

The SMF 33 is a load distribution device having a session management function, and manages a PDU session in 5G.

The gNB 31 is a 5G base station that provides new radio (NR), and accommodates the UE 41.

The UE 41 is a user terminal operated by a user, and is used to transmit and receive communication data to and from the UPF 21.

Here, in a case where there is no terminal device between the gNB 31 and the UPFs 21 to 23, IP address information of each of the UPFs 21 to 23 is disclosed to the outside (the UE 41 side) and does not satisfy (Requirement 1).

FIG. 14 is a configuration diagram in which a network address translation (NAT) device 34 is added to the 5GC system of FIG. 13.

The NAT device 34 discloses one global IP address to the UE 41 side, and performs address translation by NAT between the gNB 31 and the UPFs 21 to 23. Thereby, the IP address information of each of the UPFs 21 to 23 satisfies (Requirement 1) by the NAT device 34 hiding the information. However, since the NAT device 34 does not perform load distribution, (Requirement 2) is not satisfied.

(Requirement 2) will be described with reference to FIG. 15 and FIG. 16.

First, there are various communication protocols used in public communication services. For the following representative protocols, load distribution can be performed by an existing load balancer product.
General Web protocol in the related art such as HTTP and HTTPS
Voiceover IP (VoIP) protocol such as SIP Requirement 1)

On the other hand, there is no existing load balancer product that can support a wide variety of protocols existing for each NF like 5G. That is, there is no load distribution in which the stateful C-plane and the U-plane in 5G cooperate with each other. In a case where a load balancer product that can support a wide variety of protocols is implemented by containers, each container needs to have a unique IP and perform communication with the opposing device, which is costly.

FIG. 15 is a configuration diagram in which a 4th generation (4G) mobile communication system is connected to the 5GC system of FIG. 13.

In a non-standalone 5GC, a 4G system also coexists. As a 4G system, an evolved Node B (eNB) 35 accommodating the UE 42 is connected to the UPFs 21 to 23 similarly to the gNB 31. Note that each of the UPFs 21 to 23 functions as a serving gateway (S-GW) and a packet data network gateway (P-GW) for the 4G.

FIG. 16 is a configuration diagram in which a C-plane signal and a U-plane signal are added to the system of FIG. 15.

In response to a PDU session establishment request from the UE 41, the C-plane indicated by a dashed arrow notifies the UE 41 of a selection result (load distribution destination) of the UPF 21 that is responsible for the U-plane as a session counterpart via an illustrated path.

The U-plane indicated by a solid arrow is communication between the UE 41 and the DN 11 by a PDU session via the UPF 21 notified in the U-plane.

In 5G, the C-plane and the U-plane are separated, and the stateful C-plane and the U-plane cooperate with each other. Thereby, call control processing of the PDU session is established. For this reason, even in a case where it is attempted to perform load distribution of the U-plane via the UPF 21 selected by the C-plane, load distribution cannot be implemented using only the session information of the U-plane. For example, it is assumed that an amount of communication between the UE 41 and the DN 11 increases. In a case where the session information of the U-plane is associated with the fixed UPF 21, it is difficult to distribute a part of the communication amount processed by the UPF 21 also to the other UPFs 22 and 23. That is, a load distribution mechanism considering both the C-plane and the U-plane is required.

Therefore, a main object of the present invention is to implement stateful load distribution while hiding internal network information of a load distribution destination.

### Solution to Problem

In order to solve the above problem, a load distribution device according to the present invention has the following features.

There is provided a load distribution device that manages information including an ID of a session, the load distribution device being configured to:
receive a session establishment request including the ID of the session from a user terminal, and select a processing server as a load distribution destination from a plurality of processing servers;
return address information of a gateway that relays the session to the user terminal;
notify the gateway of correspondence information between the ID of the session and the selected processing server; and
perform control such that a data signal which arrives at the gateway from the user terminal via the session is transferred to the selected processing server.

### Advantageous Effects of Invention

According to the present invention, it is possible to implement stateful load distribution while hiding information of an internal network of a load distribution destination.

### BRIEF DESCRIPTION OF DRAWINGS

FIG. 1 is a configuration diagram illustrating a 5GC system according to the present embodiment.

FIG. 2 is a configuration diagram in which a proxy is added to the 5GC system of FIG. 1 according to the present embodiment.

FIG. 3 is a first sequence diagram in which the 5GC system performs a PDU session establishment procedure.

FIG. 4 is a second sequence diagram in which the 5GC system performs a PDU session establishment procedure.

FIG. 5 is a third sequence diagram in which the 5GC system performs a PDU session establishment procedure.

FIG. 6 is a configuration diagram in which a path of a C-plane flowing from a UE to a UPF is emphasized compared to the 5GC system of FIG. 1 according to the present embodiment.

FIG. 7 is a configuration diagram in which a path of the C-plane flowing from a UE to a UPF is emphasized compared to the 5GC system of FIG. 2 according to the present embodiment.

FIG. 8 is a configuration diagram in which a return path of the C-plane of FIG. 6 according to the present embodiment is emphasized. The C-plane flows in the following order.

FIG. 9 is a configuration diagram in which a return path of the C-plane of FIG. 7 according to the present embodiment is emphasized.

FIG. 10 is a configuration diagram in which a path of the U-plane transmitted after transmission of the C-plane in FIG. 8 according to the present embodiment is emphasized.

FIG. 11 is a configuration diagram in which a path of the U-plane transmitted after transmission of the C-plane in FIG. 8 according to the present embodiment is emphasized.

FIG. 12 is a hardware configuration diagram of each device of the 5GC system according to the present embodiment.

FIG. 13 is a configuration diagram illustrating an example of a 5GC system.

FIG. 14 is a configuration diagram in which a network address translation (NAT) device is added to the 5GC system of FIG. 13.

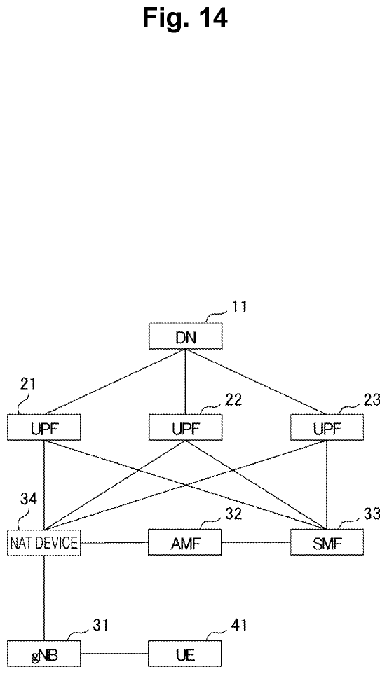

FIG. 15 is a configuration diagram in which a 4th generation (4G) mobile communication system is connected to the 5GC system of FIG. 13.

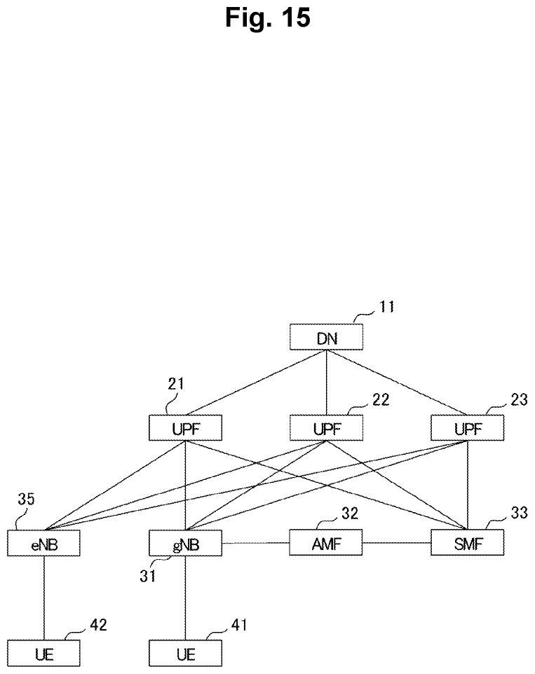

FIG. 16 is a configuration diagram in which a C-plane signal and a U-plane signal are added to the system of FIG. 15.

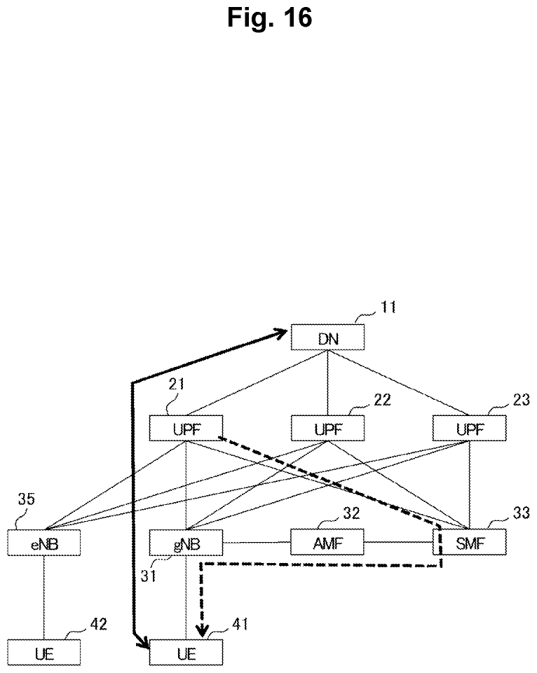

### DESCRIPTION OF EMBODIMENTS

Hereinafter, an embodiment of the present invention will be described in detail with reference to the drawings.

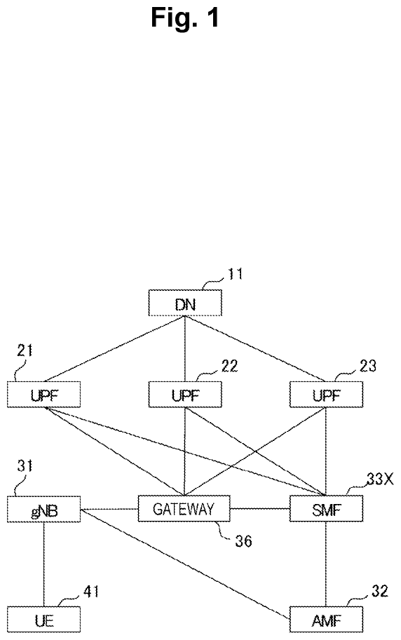

FIG. 1 is a configuration diagram illustrating a 5GC system according to the present embodiment.

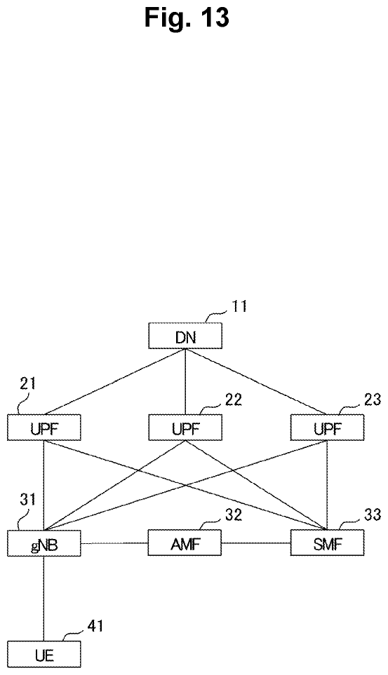

The 5GC system of FIG. 1 is different from the 5GC system of FIG. 13 in that the SMF 33 is replaced with the SMF 33X and a gateway 36 is added between the gNB 31 and the UPFs 21 to 23. Thereby, the gateway 36 hides configurations of the UPFs 21 to 23, which are a container group as a target for load distribution, from the UE 41 outside.

Further, the SMF 33X has a function of informing (notifying) the gateway 36 of state information of the C-plane. The state information of the C-plane is an adjustment result of the PDU session, and is, for example, “correspondence information between the UPF 21 selected as a load distribution destination and a PDU session ID (TE-ID)” to be described later. Thereby, the gateway 36 can perform load distribution of the U-plane in consideration of both the C-plane and the U-plane.

The SMF 33X manages information including an ID of the PDU session. That is, the SMF 33X performs control such that a data signal which arrives at the gateway 36 from the UE 41 via the PDU session is transferred to the selected UPF (hereinafter, it is assumed that the UPF 21 is selected) by the following procedure.
The SMF 33X receives a PDU session establishment request including the ID of the PDU session from the UE 41, and selects the UPF 21 as a load distribution destination from a plurality of UPFs 21, 22, and 23.
The SMF 33X responds to the UE 41 with address information of the gateway 36 that relays the PDU session.
The SMF 33X notifies the gateway 36 of the correspondence information between the ID of the PDU session and the selected UPF 21. The gateway 36 translates a transmission destination of a data signal, which is received from the UE 41 via the PDU session, from address information of the gateway 36 to address information of the UPF 21 selected by referring to the correspondence information based on the ID of the PDU session.

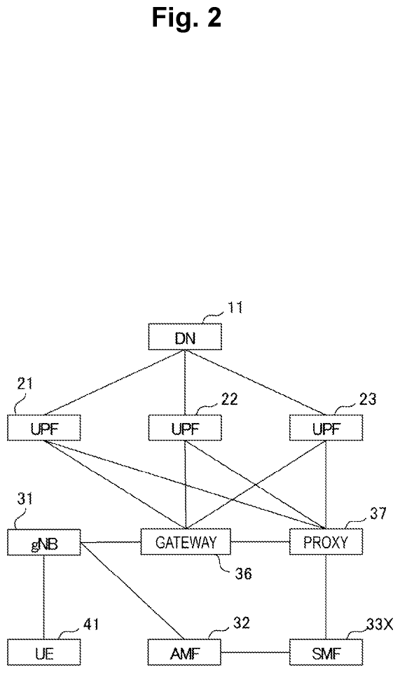

FIG. 2 is a configuration diagram in which a proxy 37 is added to the 5GC system of FIG. 1.

The proxy 37 is connected between the SMF 33X and the UPFs 21 to 23. In addition, in FIG. 1, a function of notifying the gateway 36 of the state information of the C-plane is provided in the SMF 33X. On the other hand, in FIG. 2, the function is provided in the proxy 37.

The proxy 37 receives the PDU session establishment request from the UE 41, transfers the establishment request to the SMF 33X, and notifies the gateway 36 of the correspondence information between the ID of the PDU session and the UPF 21 selected by the SMF 33X instead of the SMF 33X.

Thereby, an influence on the existing SMF 33 can be reduced, and an amount of a change in implementation of the existing SMF 33 can be reduced.

Hereinafter, specific processing of the 5GC system in FIG. 1 and FIG. 2 will be described using, as an example, a PDU session establishment procedure (standard sequence) of a standard specification.

Note that the PDU session establishment procedure is defined in Section 4.3.2.2 “UE Requested PDU Session Establishment” of the standard specification “ETSI TS 123 502” published by the European Telecommunications Standards Institute (ETSI).

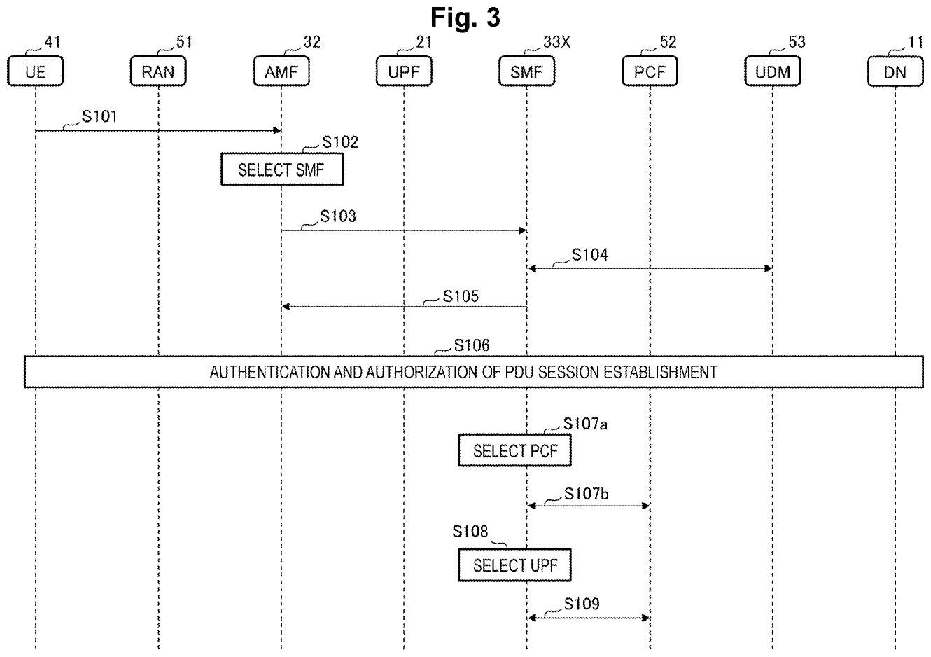

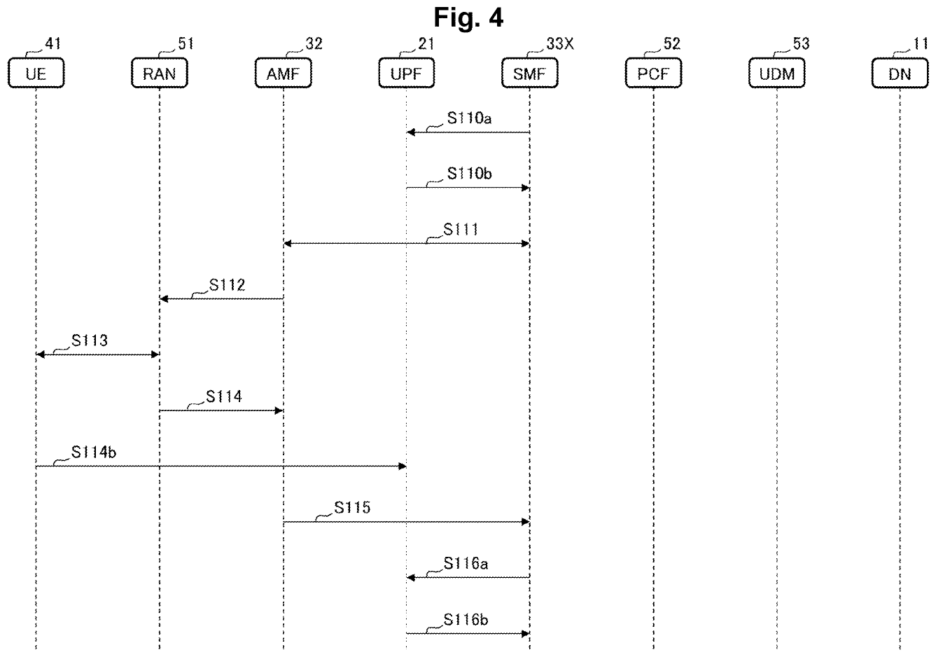

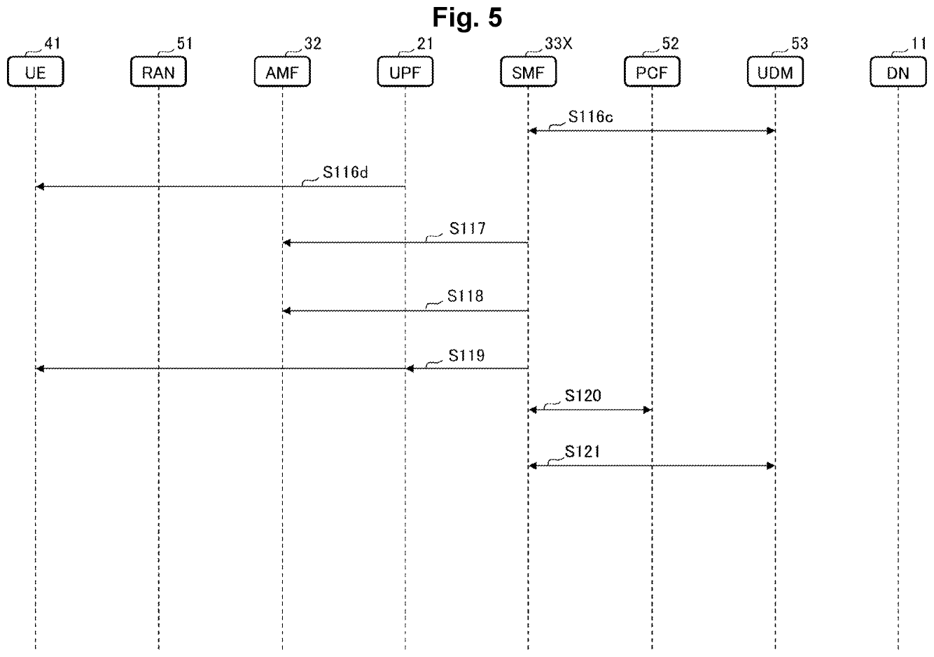

In the following description, FIG. 3 to FIG. 5 are sequence diagrams illustrating standard sequences. By performing processing in the order of FIG. 3, FIG. 4, and FIG. 5, a PDU session is established in the C-plane, and the U-plane flows via the PDU session.

FIG. 3 is a first sequence diagram in which the 5GC system performs a PDU session establishment procedure.

Note that, in FIG. 3, the following configuration is further added to the 5GC system of FIG. 13.
A radio access network (RAN) 51 is an access network device disposed in a base station or the like.
A policy control function (PCF) 52 is a policy control device.
A unified data management (UDM) 53 is a device that holds subscriber-related information.

S101 is processing in which a PDU session establishment request including a PDU session ID (TE-ID) is transmitted from the UE 41 to the AMF 32 (PDU session establishment request).

S102 is processing in which the AMF 32 selects the SMF 33X (SMF selection).

S103 is processing in which a session management request is transmitted from the AMF 32 to the SMF 33X in response to the request in S101 (Nsmf_PDUSession_CreateSMContext Request).

S104 is processing in which the SMF 33X requests the UDM 53 to read subscriber information corresponding to the session management requested in S103 and to transmit the subscriber information as a response (Subscription retrieval/Subscription for updates).

S105 is processing in which a response including the subscriber information in S104 is transmitted from the SMF 33X to the AMF 32 as a response to the request in S103 (Nsmf_PDUSession_CreateSMContext Response).

S106 is processing in which each device of the 5GC system performs authentication and authorization of the PDU session establishment (PDU Session authentication/authorization).

S107a is processing in which the SMF 33X selects the PCF 52 to be processed in S107b (PCF selection).

S107b is processing in which an SM policy association establishment request is transmitted from the SMF 33X to the PCF 52 (SM Policy Association Establishment) or processing in which a request for modification of an SM policy association initiated by the SMF 33X is transmitted from the SMF 33X to the PCF 52 (SMF initiated SM Policy Association Modification).

S108 is processing in which the SMF 33X selects the UPF 21 to be processed in S110a of FIG. 4 (UPF selection).

S109 is processing in which a request for modification of SM policy association initiated by the SMF 33X is transmitted from the SMF 33X to the PCF 52 (SMF initiated SM Policy Association Modification).

The processing of S109 is followed by processing of FIG. 4.

FIG. 4 is a second sequence diagram in which the 5GC system performs a PDU session establishment procedure.

S110a is processing in which a request for establishment/modification of an N4 session is transmitted from the SMF 33X to the UPF 21 (N4 Session Establishment/Modification Request).

S110b is processing in which a response to the request of S110a is transmitted from the UPF 21 to the SMF 33X (N4 Session Establishment/Modification Response).

S111 is processing in which an ACK to the PDU establishment request is transmitted from the SMF 33X to the AMF 32 (Namf_Communication_N1N2MessageTransfer). The ACK includes the IP address of the UPF 21 that is assigned to the PDU session ID.

S112 is processing in which an N2 PDU session request (NAS message) is transmitted from the AMF 32 to the RAN 51 (N2 PDU Session Request (NAS msg)).

S113 is processing in which a request for setup of esources of the RAN 51 is transmitted from the RAN 51 to the UE 41 (RAN-specific resource setup (PDU Session Establishment Accept)).

S114 is processing in which a response to the request of S112 is transmitted from the RAN 51 to the AMF 32 (N2 PDU Session Request Ack).

S114b is processing in which first uplink data is transmitted from the UE 41 to the UPF 21.

S115 is processing in which a request for update of the PDU session is transmitted from the AMF 32 to the SMF 33X (Nsmf_PDUSession_UpdateSMContext Request).

S116a is processing in which a request for modification of the N4 session is transmitted from the SMF 33X to the UPF 21 (N4 Session Modification Request).

S116b is processing in which a response to the request of S116a is transmitted from the UPF 21 to the SMF 33X (N4 Session Modification Response).

FIG. 5 is a third sequence diagram in which the 5GC system performs a PDU session establishment procedure.

S116c is processing in which a request for registration of a PDU session is transmitted from the SMF 33X to the UDM 53.

S116d is processing in which first downlink data is transmitted from the UPF 21 to the UE 41.

S117 is processing in which a response to the request of S115 is transmitted from the SMF 33X to the AMF 32 (Nsmf_PDUSession_UpdateSMContext Response).

S118 is processing in which a notification of a status of the PDU session is transmitted from the SMF 33X to the AMF 32 (Nsmf_PDUSession_SMContextStatusNotify).

S119 is processing in which a request for configuration of an IPV6 address is transmitted from the SMF 33X to the UPF 21 and the UE 41 (IPv6 Address Configuration).

S120 is processing in which a request for modification of SM policy association initiated by the SMF 33X is transmitted from the SMF 33X to the PCF 52 (SMF initiated SM Policy Association Modification).

S121 is processing in which a request for release of the registration in S116c is transmitted from the SMF 33X to the UDM 53 (Unsubscription).

The PDU session establishment procedure in the present embodiment differs from the standard specification mainly in the following three points.

(Difference 1) A procedure in which the SMF 33X notifies the gateway 36 of the correspondence information between the UPF 21 selected as the load distribution destination and the PDU session ID (TE-ID) is added.

(Difference 2) A procedure in which the SMF 33X notifies the UE 41 of the IP address of the gateway 36 is added.

(Difference 3) The gateway 36 transfers the U-plane data to the UPF 21 corresponding to the PDU session ID.

The load distribution system according to the present embodiment completes preparation for data transfer by performing the processing of (Difference 1) and then performing the processing of (Difference 2). After the preparation, the load distribution system according to the present embodiment performs the processing of (Difference 3). Thereby, it is possible to implement a scheme for implementing load distribution of the PDU session in which the C-plane and the U-plane cooperate with each other while hiding the configuration of the UPF 21.

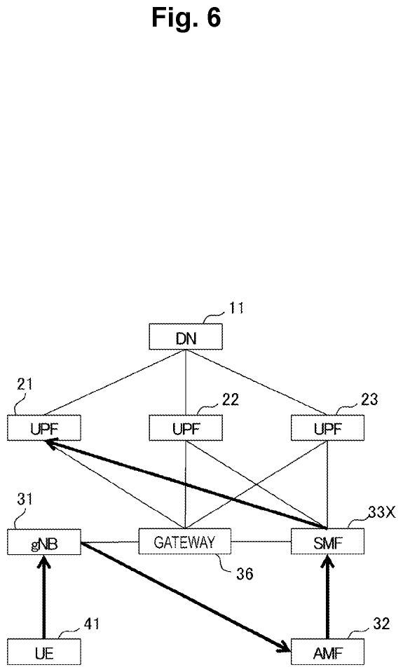

FIG. 6 is a configuration diagram in which a path of the C-plane flowing from the UE 41 to the UPF 21 is emphasized compared to the 5GC system of FIG. 1. The C-plane flows in the following order.
UE 41→gNB 31→AMF 32: A signal of S101 flows in this order (a PDU session establishment request).
AMF 32→SMF 33X: A signal of S103 flows in this order (a request of session management for the request of S101).

Here, the SMF 33X selects the UPF 21 (as a load distribution destination) that is responsible for the U-plane (S108). Note that the SMF 33X may change the UPF 21 that is previously determined as the load distribution destination to the UPF 22 or the UPF 23 by referring to the current load status of each of the UPFs 21 to 23.
SMF 33X→UPF 21: A signal of S110a flows in this order (a request for establishment/modification of an N4 session).

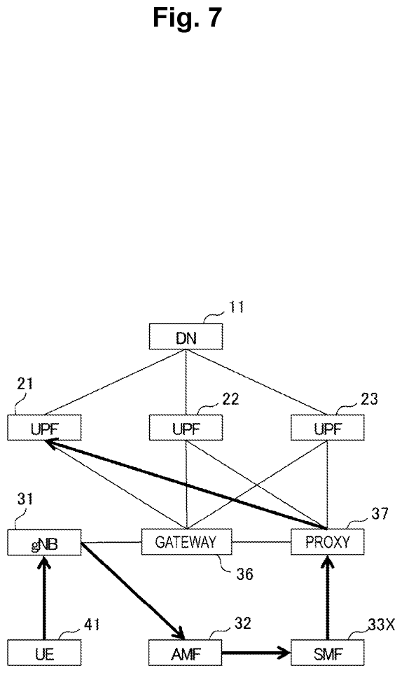

FIG. 7 is a configuration diagram in which a path of the C-plane flowing from the UE 41 to the UPF 21 is emphasized compared to the 5GC system of FIG. 2.

The signal (SMF 33X→UPF 21) in S110a of FIG. 6 flows through a path of SMF 33X→proxy 37→UPF 21 in FIG. 7. Flows of other signals are the same in FIG. 6 and FIG. 7.

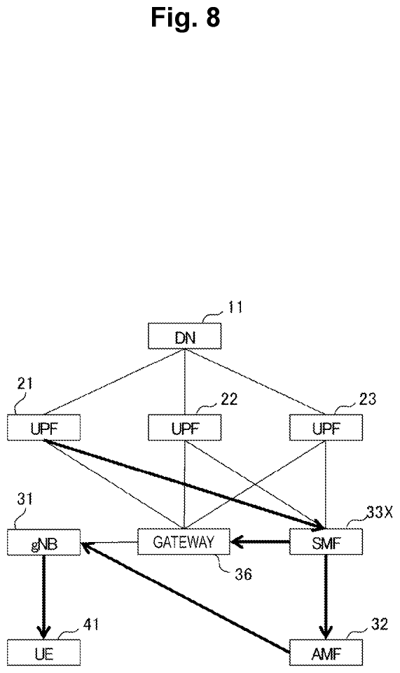

FIG. 8 is a configuration diagram in which a return path of the C-plane of FIG. 6 is emphasized. The C-plane flows in the following order.
UPF 21→SMF 33X: A signal of S110b flows in this order (transmission of a response to the request of S110a).
SMF 33X→AMF 32: A signal of S111 flows in this order (transmission of ACK to the PDU establishment request). The signal of S111 in the standard sequence includes the IP address of the UPF 21 that is responsible for the U-plane and corresponds to the PDU session ID. The load distribution system according to the present embodiment includes the IP address information of the gateway 36 in the signal of S111 instead of the IP address of the UPF 21 (Difference 2).

The IP address information of the gateway 36 is, for example, an IP address of an interface of the gateway 36 that is adjacent to the gNB 31 and clusters the UPFs 21. Thereby, the IP address information of the gateway 36 is also included in subsequent signals of S112 and S113, and is notified to the UE 41. In addition, since the IP address of the UPF 21 is not notified to the UE 41, the configuration of the UPF 21 is hidden.
SMF 33X→gateway 36: A procedure of notifying the correspondence information between the UPF 21 selected to be responsible for the U-plane and the PDU session ID (TE-ID) is added to the standard sequence (Difference 1). The procedure of (Difference 1) is desirably executed between S110b and S111, and is completed before S113 at the latest.
AMF 32→gNB 31 (RAN 51): A signal of S 112 flows in this order (transmission of an N2 PDU session request).
gNB 31 (RAN 51)→UE 41: A signal of S113 flows in this order (establishment of resources of the RAN 51).

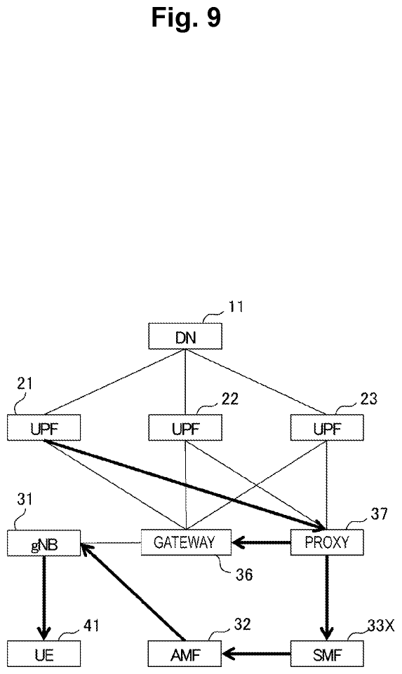

FIG. 9 is a configuration diagram in which a return path of the C-plane of FIG. 7 is emphasized. The following description is a difference between FIG. 8 and FIG. 9, and flows of other signals are the same in FIG. 8 and FIG. 9.
A signal (UPF 21→SMF 33X) of S110b in FIG. 8 flows through a path of UPF 21→proxy 37→SMF 33X in FIG. 9.
A device that executes a procedure (Difference 1) of notifying the gateway 36 of the correspondence information between the UPF 21 selected as the load distribution destination and the PDU session ID (TE-ID) is replaced from the SMF 33X to the proxy 37.

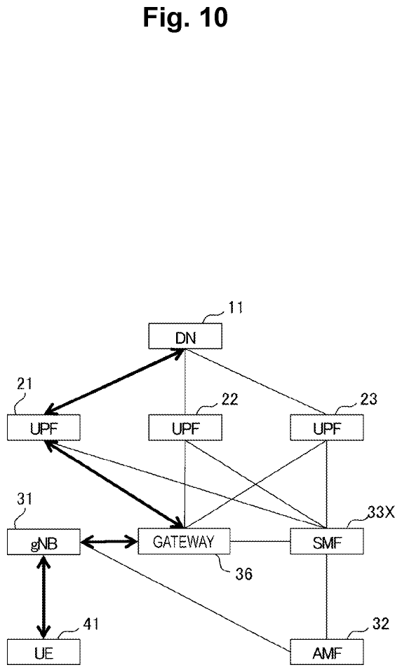

FIG. 10 is a configuration diagram in which a path of the U-plane transmitted after transmission of the C-plane in FIG. 8 is emphasized.

First, the UE 41 directly notifies the UPF 21 of the first uplink data in S114b of the standard sequence. On the other hand, in FIG. 10, uplink data such as the first uplink data of S114b is transmitted in the order of UE 41→gNB 31→gateway 36→UPF 21→DN 11.

Here, in a case of receiving the U-plane data from the UE 41 via the PDU session, the gateway 36 determines the UPF 21 as a transfer destination (load distribution destination) of the U-plane data by network address translation (NAT), and transfers the U-plane data to the UPF 21 (Difference 3).

The network address translation is processing in which the gateway 36 translates the PDU session ID (TE-ID) to the IP address of the corresponding UPF 21 by referring to the correspondence information notified by (Difference 1). Thereby, the configuration of the UPF 21 is hidden from the UE 41.

Similarly, the first downlink data of S116d in the standard sequence is also notified via the gateway 36 in the order of DN 11→UPF 21→gateway 36→gNB 31→UE 41 instead of being directly notified from the UPF 21 to the UE 41.

Therefore, the gateway 36 is notified of the PDU session information for return data (downlink data) from the SMF 33X after S116b. Thereby, the PDU session for the return data is established.

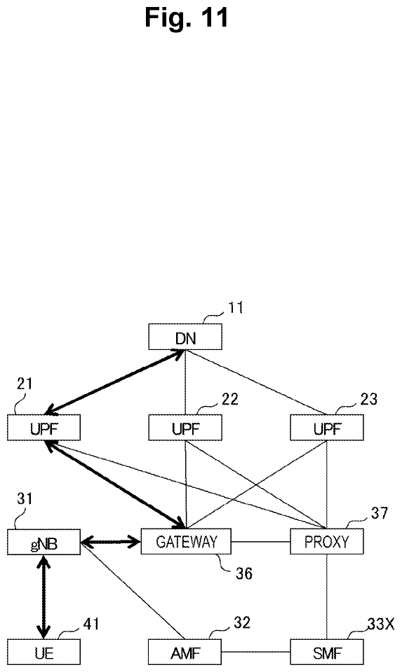

FIG. 11 is a configuration diagram in which a path of the U-plane transmitted after transmission of the C-plane in FIG. 8 is emphasized.

Regardless of the presence or absence of the proxy 37, data in FIG. 11 is also transmitted via the same path as the path in FIG. 10.

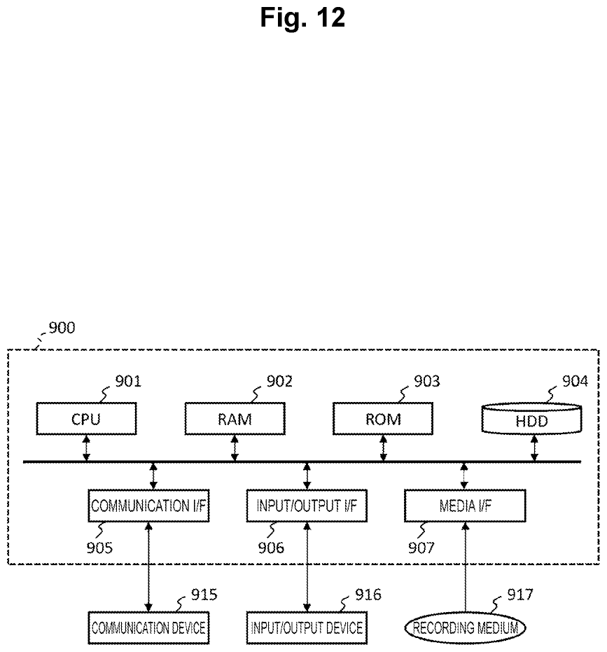

FIG. 12 is a hardware configuration diagram of each device (the SMF 33X, the gateway 36, or the like) of the 5GC system according to the present embodiment.

Each device of the 5GC system is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. The CPU 901 controls each unit by executing a program (also referred to as an application or an app for abbreviation thereof) read into the RAM 902. The program may be distributed via a communication line or may be distributed by being recorded on the recording medium 917 such as a CD-ROM.

### Effects

According to the present invention, there is provided an SMF 33X that manages information including an ID of a PDU session, the SMF 33X being configured to:
receive a PDU session establishment request including the ID of the PDU session from a UE 41, and select a UPF 21 as a load distribution destination from a plurality of UPFs 21;
return address information of a gateway 36 that relays the PDU session to the UE 41;
notify the gateway 36 of correspondence information between the ID of the PDU session and the selected UPF 21; and
perform control such that a data signal which arrives at the gateway 36 from the UE 41 via the PDU session is transferred to the selected UPF 21.

Thereby, the UE 41 provided outside is notified of the address information of the gateway 36 that relays the session without being notified of the address information of the selected UPF 21. Therefore, in an architecture in which the C-plane and the U-plane are separated, it is possible to implement stateful load distribution while hiding information of an internal network of a load distribution destination.

According to the present invention, there is provided a load distribution system including: the SMF 33X; and the gateway 36, in which the gateway 36 translates a transmission destination of a data signal which is received from the UE 41 via the PDU session, from the address information of the gateway 36 to address information of the UPF 21 which is selected by referring to the correspondence information based on the ID of the PDU session.

Thereby, it is not necessary to apply an influence of a change in the network configuration due to scale-out of the UPF 21 or the like to the UE 41 that is the opposing device.

In the present invention, the load distribution system further includes: a proxy 37. The proxy 37 receives the PDU session establishment request from the UE 41, transfers the PDU session establishment request to the SMF 33X, and notifies the gateway 36 of the correspondence information between the ID of the PDU session and the UPF 21 selected by the SMF 33X instead of the SMF 33X.

Thereby, processing for which the existing SMF 33X is responsible is reduced, and thus, it is possible to reduce development costs for changing the existing SMF 33X.

### REFERENCE SIGNS LIST

11 DN
21-23 UPF (processing server)
31 gNB
32 AMF
33, 33X SMF (load distribution device)
34 NAT device
35 eNB
36 Gateway
37 Proxy
41, 42 User terminal (UE)
51 RAN
52 PCF
53 UDM

1. A load distribution device, comprising one or more computers, that manages information including an ID of a session, the load distribution device being configured to:
receive a session establishment request including the ID of the session from a user terminal, and select a processing server as a load distribution destination from a plurality of processing servers;
return address information of a gateway configured to relay the session to the user terminal;
notify the gateway of correspondence information between the ID of the session and the selected processing server; and
transfer a data signal which arrives at the gateway from the user terminal via the session to the selected processing server.

2. A load distribution system comprising:
a load distribution device, comprising one or more computers, that manages information including an ID of a session, the load distribution device being configured to:
receive a session establishment request including the ID of the session from a user terminal, and select a processing server as a load distribution destination from a plurality of processing servers;
return address information of a gateway configured to relay the session to the user terminal
notify the gateway of correspondence information between the ID of the session and the selected processing server; and
transfer a data signal which arrives at the gateway from the user terminal via the session to the selected processing server; and
the gateway, wherein
the gateway is configured to translate a transmission destination of a data signal which is received from the user terminal via the session, from the address information of the gateway to address information of the processing server which is selected by referring to the correspondence information based on the ID of the session.

3. The load distribution system according to claim 2 further comprising:
a proxy, wherein:
the proxy is configured to receive the session establishment request from the user terminal, transfer the session establishment request to the load distribution device, and notify the gateway of the correspondence information between the ID of the session and the processing server selected by the load distribution device instead of the load distribution device.

4. A load distribution method performed by a load distribution device, comprising one or more computers, that manages information including an ID of a session, the method causing the load distribution device to execute a process comprising:
receiving a session establishment request including the ID of the session from a user terminal;
selecting a processing server as a load distribution destination from a plurality of processing servers;
returning address information of a gateway configured to relay the session to the user terminal;
notifying the gateway of correspondence information between the ID of the session and the selected processing server; and
transferring a data signal which arrives at the gateway from the user terminal via the session to the selected processing server.

5. (canceled)
